(19) United States
(12) Patent Application Publication
(10) Pub. No.: US 2025/0111401 A1
(43) Pub. Date: Apr. 3, 2025

(54) METHOD FOR PROVIDING VEHICLE SERVICE

(71) Applicant: TOYOTA JIDOSHA KABUSHIKI KAISHA, Toyota-shi (JP)

(72) Inventors: Mitsuaki TOMITA, Toyota-shi (JP); Tohru Nakamura, Toyota-shi (JP); Hirofumi MATSUYAMA, Nagoya-shi (JP); Hiroshi ASHIDA, Nukata-gun (JP)

(73) Assignee: TOYOTA JIDOSHA KABUSHIKI KAISHA, Toyota-shi (JP)

(21) Appl. No.: 18/667,058

(22) Filed: May 17, 2024

(30) Foreign Application Priority Data
Sep. 29, 2023 (JP) 2023-169150

(51) Int. Cl. G06Q 30/0207; B60L 53/66; G06Q 50/47

(52) U.S. Cl. CPC G06Q 30/0207; B60L 53/665; G06Q 50/47

(57) ABSTRACT

The taxi vehicles are electrified vehicle that can be charged from EVSE. When the pickup location for the taxi vehicle is a standby location where EVSE is installed, a discount amount A is set. When the drop-off location from the taxi vehicle is within the predetermined range from EVSE, the discount amount B is set. The discount amount A+B is set when the pickup location is a standby location where EVSE is installed and the drop-off location is within a predetermined range from EVSE. In order to obtain incentives, users are more likely to get in and out of EVSE, so that recharging times can be efficiently secured.

### CROSS-REFERENCE TO RELATED APPLICATION

This application claims priority to Japanese Patent Application No. 2023-169150 filed on Sep. 29, 2023, incorporated herein by reference in its entirety.

### BACKGROUND

### 1. Technical Field

The present disclosure relates to methods for providing a vehicle service.

### 2. Description of Related Art

Japanese Unexamined Patent Application Publication No. 2019-168922 (JP 2019-168922 A) discloses a vehicle dispatch system using electrified vehicles as taxi vehicles. In this vehicle dispatch system, the remaining battery capacities of the electrified vehicles are considered in terms of the power required to travel a route including a destination, and an electrified vehicle with the remaining battery capacity matched with the required power is dispatched also in consideration of its standby time. It is described that the overall transportation efficiency of the electrified vehicles is thus improved.

### SUMMARY

The time required to charge the battery of an electrified vehicle is longer compared to the time required to refuel a vehicle equipped with an internal combustion engine. Therefore, when electrified vehicles are used for a vehicle service (passenger transportation service) such as a taxi service, it is desired to efficiently secure their charging times.

It is an object of the present disclosure to efficiently secure charging times in a vehicle service using electrified vehicles.

A method for providing a vehicle service according to the present disclosure is a method for providing a vehicle service for transporting a user in exchange for payment of a fee from a pickup location to a drop-off location.

A vehicle in which the user rides is an electrified vehicle that is chargeable with a charging equipment.
The method includes: determining whether either or both of the pickup location and the drop-off location are located within a predetermined range from a location of the charging equipment; and
providing an incentive when either or both of the pickup location and the drop-off location are located within the predetermined range.

According to this method, the incentive is provided when either or both of the pickup location and the drop-off location are located within the predetermined range from the charging equipment. For example, when the pickup location or the drop-off location is located within a predetermined straight line distance (or route distance) from the charging equipment, the incentive is provided to the user who receives the vehicle service. For example, the incentive may be a discount on the fee. Alternatively, the incentive may be points for future fee payment, purchase of other services or goods, etc.

It can be expected that the user will get on at a place located within the predetermined range from the charging equipment in order to earn the incentive. Alternatively, it can be expected that the user will get off at a place located within the predetermined range from the charging equipment in order to earn the incentive. This increases opportunities for users to get on and off at places near the charging equipment, so that charging times can be efficiently secured, and the occupancy rate of the electrified vehicles can be improved.

Preferably, the incentive may be provided when the pickup location is a standby location where the charging equipment is installed.

According to this method, since the user gets on at the standby location where the charging equipment is installed, such as a taxi stand or taxi office where the charging equipment is installed. Therefore, charging can be performed during standby time, so that charging times can be efficiently secured.

Preferably, when both the pickup location and the drop-off location are located within the predetermined range, a higher level of the incentive may be provided than when either the pickup location or the drop-off location is located within the predetermined range.

According to this method, it can be expected that the user will get on at a pickup location located within the predetermined range from the charging equipment and get off at a drop-off location located within the predetermined range from the charging equipment. Charging times can thus be more efficiently secured.

Preferably, the method may further include acquiring output power of the charging equipment located within the predetermined range, and the level of the incentive may be set according to a magnitude of the output power.

According to this method, the output power of the charging equipment located within the predetermined range from the pickup location or the drop-off location is acquired. The level of the incentive is set according to the magnitude of the output power of the charging equipment. For example, when the charging equipment is a rapid charging equipment with high output power, the incentive may be set to a higher level than when the charging equipment is a normal charging equipment because the charging time is shorter than normal charging.

Preferably, the incentive may be a discount on the fee.

According to this method, a fee that is of high interest to users is discounted. This increases users' desire to earn the incentive.

According to the present disclosure, it is possible to efficiently secure charge times in the vehicle service using electrified vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a vehicle service using a taxi vehicle according to the present embodiment;

FIG. 2 is a flowchart illustrating an example of a fee (fare) discount process performed in ECU;

FIG. 3A is a diagram illustrating an example of a fare meter 81 according to the present embodiment;

FIG. 3B is a diagram illustrating an example of a fare meter 81 according to the present embodiment;

FIG. 4 is a diagram for describing a vehicle service in Embodiment 2;

FIG. 5 is a flowchart illustrating a partial process of the dispatch service executed in the server;

FIG. 6A is a diagram showing a display screen (touch panel display) of a mobile terminal; and

FIG. 6B is a diagram illustrating a display screen (touch panel display) of a mobile terminal.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

### First Embodiment

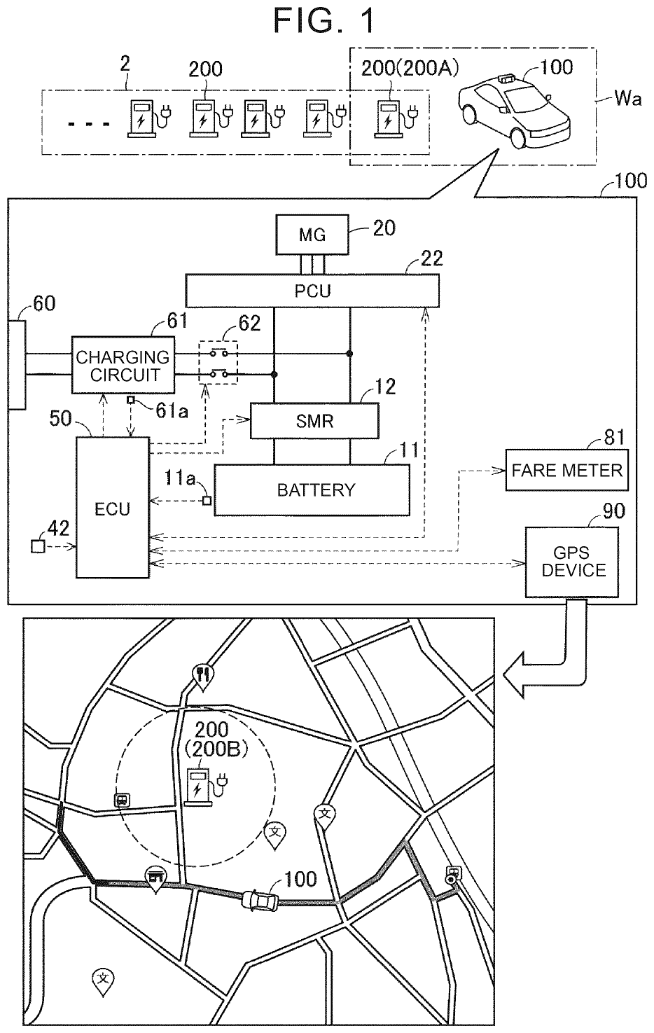

FIG. 1 is a diagram illustrating an example of a vehicle service using a taxi vehicle 100 according to the present embodiment. The vehicle service is a passenger transportation service performed by the taxi vehicle 100. The taxi vehicle 100 is an electrified vehicle and is an externally chargeable vehicle by an EVSE 200 of an EVSE group 2. EVSE stands for a charging equipment for a vehicle (electric vehicle supply equipment). Each EVSE 200 of the EVSE group 2 is scattered and installed at each location. In the present embodiment, an EVSE 200A is a charging equipment installed in a standby location Wa (for example, a taxi landing or a sales office) of the taxi vehicle 100.

The taxi vehicle 100 includes a battery 11, a system main relay (SMR) 12, a motor generator (MG) 20, a power control unit (PCU) 22, and an electronic control unit (hereinafter, also referred to as electronic control unit (ECU) 50. ECU 50 includes a processor, a random access memory (RAM), a storage device, and the like.

The battery 11 is configured to be chargeable and dischargeable. The taxi vehicle 100 is an electrified vehicle (xEV) configured to be able to travel using electric power stored in the battery 11. In the present embodiment, the taxi vehicle 100 is a BEV that does not include an internal combustion engine. However, the taxi vehicle 100 may be a PHEV including an internal combustion engine. The battery 11 may be a lithium-ion secondary battery, a nickel-hydrogen secondary battery, or the like.

The taxi vehicle 100 includes a BMS (Battery Management System) 11a that monitors the status of the battery 11. BMS 11a includes various sensors that detect the status of the battery 11 (e.g., voltage, current, and temperature), and outputs the detected data to ECU 50. BMS 11a may further include a SOC (State Of Charge) estimation function in addition to the sensor function.

The taxi vehicle 100 includes an inlet 60 for charging electric power supplied from the EVSE 200. The taxi vehicle 100 further includes a charging circuit 61 and a charging relay 62. The charging circuit 61 and the charging relays 62 are controlled by an ECU 50. When the battery 11 is charged, the connector of the power cable of the EVSE 200 is connected to the inlet 60. Then, the battery 11 is charged using the electric power supplied from the EVSE 200 by closing the charging relays 62.

The MG 20 of the taxi vehicle 100 is, for example, a three-phase AC motor generator. The MG 20 functions as a driving motor of the taxi vehicle 100. The PCU 22 includes circuitry for driving MG 20 using power supplied from the battery 11. The PCU 22 includes inverters and converters, for example. The MG 20 is driven by PCU 22 to rotate the drive wheels of the taxi vehicles 100. The MG 20 performs regenerative power generation and outputs the generated electric power to the battery 11 via PCU 22. The SMR 12 switches the connection/disconnection of the electric path from the battery 11 to PCU 22. Each of SMR 12 and PCU 22 is controlled by an ECU 50.

The taxi vehicle 100 includes a fare running meter 42, a fare meter 81, and a GPS (Global Positioning System) device 90. The GPS device 90 may be a car navigation system (hereinafter, also referred to as a “NAVI system”). The fare running meter 42 is in an operating state during the fare running of the taxi vehicle 100 and measures the fare running data. The fare running meter 42 includes a distance measuring device that measures a wage run distance and a time measuring device that measures a wage run time.

The fare meter 81 is configured to display, in real time, a fee (fare) related to passenger transportation of the taxi vehicle 100. The fare meter 81 is, for example, a taxi meter that has undergone a predetermined inspection. Although the method of calculating the fare by the fare meter 81 is arbitrary, in this embodiment, the time distance combination method is adopted, and the fare meter 81 calculates and displays the fare according to the fare distance and the fare time measured by the fare running meter 42. The fare meter 81 is configured to be capable of displaying a discount amount to be described later.

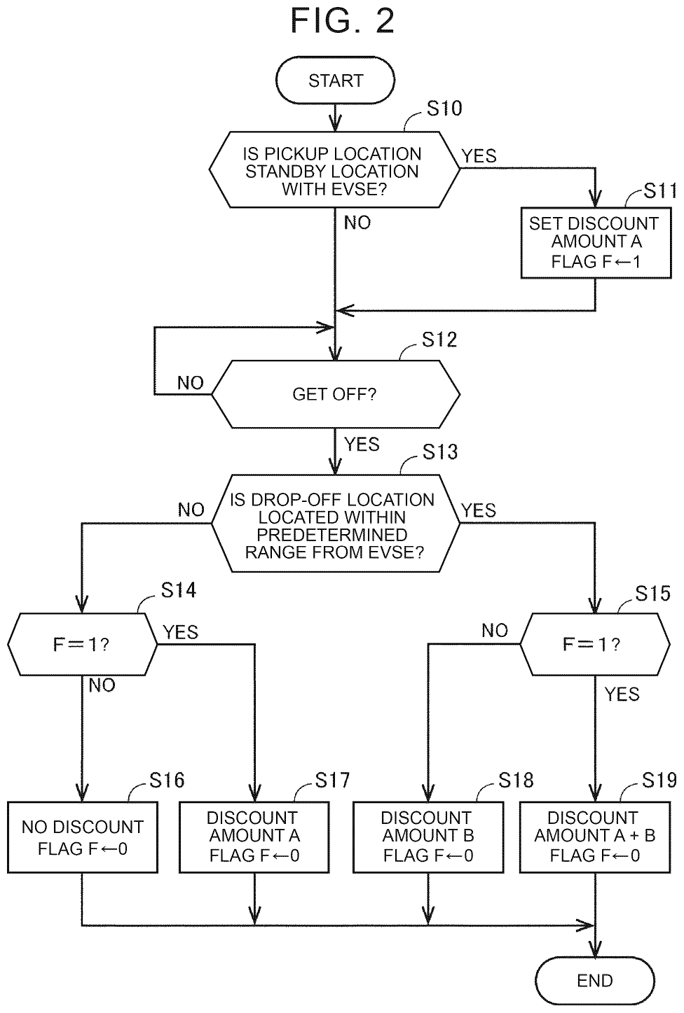

FIG. 2 is a flowchart illustrating an example of a fee (fare) discount process executed in ECU 50. In this flowchart, the process is started when the “occupied” button of the fare meter 81 is pressed. The fee discount process is an example of the “method for providing a vehicle service” of the present disclosure.

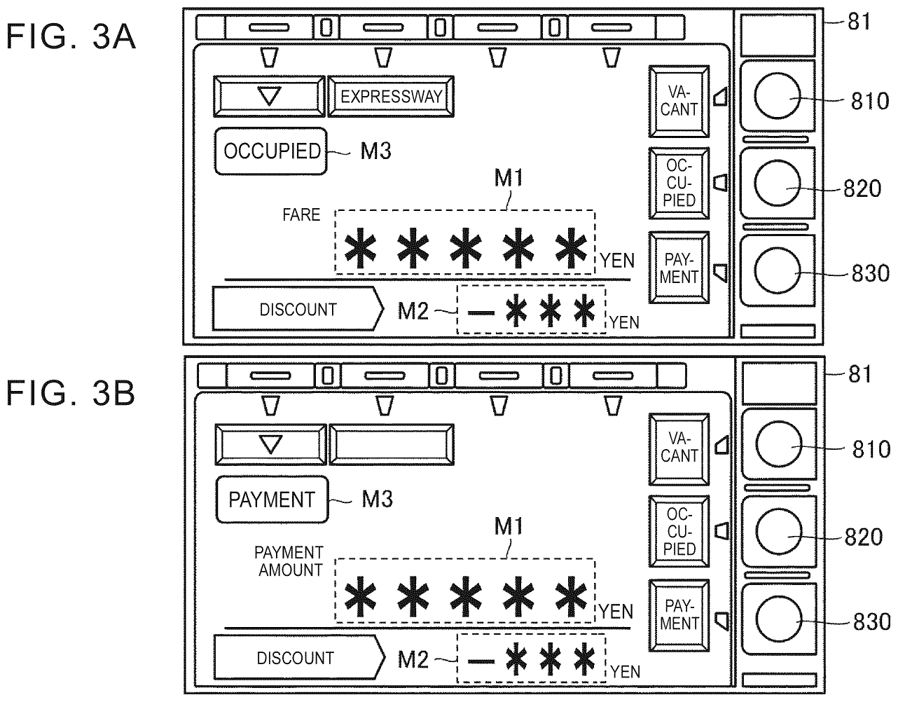

FIGS. 3A, 3B show an example of the fare meter 81 according to the present embodiment. The fare meter 81 includes a vacant button 810, an occupied button 820, and a payment button 830. When the user (passenger) gets in, the driver (crew member) of the taxi vehicle 100 presses the occupied button 820. When the occupied button 820 is pressed, the fare run is started, and the fare is displayed in real time on the display unit MI displaying the fare/payment amount. When the user gets out of the vehicle, the crew member presses the payment button 830. When the payment button 830 is pressed, the payment amount (fee) is displayed on the display unit M1. The payment amount is an amount obtained by subtracting a discount amount described later from the fare. When the user gets off, the crew presses a vacant button 810, and the taxi vehicle 100 is in an empty state. The discount amount is displayed on the display unit M2, and the status of the taxi vehicle 100 (vacant, occupied, payment) is displayed on the display unit M3.

When the user gets into the taxi vehicle 100, the occupied button 820 is

pressed, and the display unit M3 is displayed as “occupied”, as shown in FIG. 3A, the process of the flow chart of FIG. 2 is started. Referring to FIG. 2, in step (hereinafter, step is abbreviated as “S”) 10, it is determined whether or not the pickup location is the standby location Wa in which the EVSE 200 is installed. For example, when the occupied button 820 is pressed, if the position information of GPS device 90 (the position information of the taxi vehicle 100) is the standby location Wa in which the EVSE 200 is installed, an affirmative determination is made and the process proceeds to S11. If the position of GPS device 90 is not the standby location Wa in which EVSE 200 is installed when the occupied button 820 is pressed, a negative determination is made and the process proceeds to S12.

In S11, the discount amount A is set and the flag F is set to 1, and the process proceeds to S12. The initial value of the flag F is set to 0. When the discount amount A is set, the discount amount A is displayed on the display unit M2 of the fare meter 81. When a negative determination is made by S10, the discount amount is not displayed on the display unit M2.

In S12, it is determined whether the passenger (user) gets off. For example, when the payment button 830 is pressed, it is determined that the user gets off, and S13 proceeds. S12 is repeated until the payment button 830 is pressed.

In S13, it is determined whether or not the drop-off location is within a predetermined range from the installation location of EVSE 200. The installation locations of the respective EVSE 200 are stored in advance in GPS device 90 (NAVI system). When the payment button 830 is pressed, if the position data of GPS device 90 is within a predetermined distance (e.g., 500 m) from any of EVSE 200 installation locations, it is determined that the drop-off location is within a predetermined range from EVSE 200 installation location, and the process proceeds to S15. The predetermined distance may be a linear distance EVSE 200 to the taxi vehicles 100 and may be a path distance. When the payment button 830 is pressed, if the position data of GPS device 90 is not installed in any EVSE 200 within the predetermined distance, a negative determination is made and the process proceeds to S14.

In S14, it is determined whether or not the flag F is 1. When the flag F is 0, a negative determination is made and the process proceeds to S16, and when the flag F is 1, an affirmative determination is made and the process proceeds to S17. In S16, the discount amount is set to “none” (the discount amount is set to 0 yen). In S17, the discount amount is set to A (maintain the discount amount A).

In S15, it is determined whether or not the flag F is 1. When the flag F is 0, a negative determination is made and the process proceeds to S18, and when the flag F is 1, an affirmative determination is made and the process proceeds to S19. In S18, the discount amount is set to B. In S19, the discount amount is set to A+B. A+B is the discount amount A set in S11 plus B.

When S19 is processed from S16, this routine is terminated. FIG. 3B is an exemplary representation of the fare meter 81 when S19 is processed from S16. The display unit M3 displays “payment” which is the present status of the taxi vehicle 100. On the display unit M2, the discount amount set in S16 to S19 is displayed. For example, when S16 is processed, 0 yen is displayed as a discount amount (or a numerical value (amount) is not displayed). When S19 is processed, the amount (numerical value) of A+B is displayed as the discount amount. The amounts of A and B are optional, but for example, A may be 100 yen and B may be 50 yen. The display unit M1 displays the payment amount (fee). The payment amount is a value (amount) obtained by subtracting the discount fee from the fare from the time of getting on and off.

According to the above-described embodiment, when the pickup location of the taxi vehicle 100 is the standby location where EVSE 200 is installed, the discount amount A is set as the incentive-giving. When the drop-off location is within a predetermined range from the location where any EVSE 200 is installed, a discount amount B is set as an incentive grant. Further, when the pickup location is a standby location where EVSE 200 is installed and the drop-off location is within a predetermined range from the location where any EVSE 200 is installed, the discount amount A+B is set.

As a result, the user who uses the taxi vehicle 100 can expect to get in the standby location where EVSE 200 is installed in order to obtain an incentive (discount amount). In addition, in order to obtain the incentive, it is possible to expect the user to get off the vehicle at a location within a predetermined range from EVSE 200. Therefore, since the chance of getting on and off increases at a location close to EVSE 200, it is possible to efficiently secure the charge period and to improve the operation rate of the taxi vehicle 100.

### First Modification

The respective EVSE 200 included in EVSE group 2 may have different outputting power depending on the type and performance thereof. For example, when EVSE 200 is a quick charger (DC charger), the power is higher than that of a normal charger (AC charger), and the taxi vehicle 100 (battery 11) can be charged with a shorter time.

In the above-described embodiment, the discount amount is set regardless of the magnitude of the power outputted from EVSE 200. In the first modification, the discount amount is set to be higher as the power of EVSE 200 is higher (the discount amount is set to be higher).

In the first modification, in S10 and S13 (see FIG. 2), when an affirmative determination is made, the information of the output power of EVSE 200 is acquired, and a discount amount is set based on the output power. EVS 200 power is stored in advance in GPS device 90 (NAVI system) as well as in EVSE 200 locations.

For example, when an affirmative determination is made in S10, the discount amount is set to A when EVSE 200 is a normal charger, and the discount amount is set to A1 when EVSE 200 is a rapid charger. A1 is more expensive than A. Further, when an affirmative determination is made in S13, when EVSE 200 is a normal charger, the discount amount is set to B, and when EVSE 200 is a quick charger, the discount amount is set to B1. B1 is more expensive than B.

When EVSE 200 is a rapid charger, the discount amount may be set to be higher as the magnitude of the outputted power is larger. For example, when the output power is 50 kW, the discount amount may be set to A1 (B1) and when the output power is 100 kW, the discount amount may be set to A2 (B2). A2 (B2) is more expensive than A1 (B1).

According to the first modification, since EVSE in which the charge-time can be shortened is higher, there is a possibility that the operation rate of the taxi vehicle 100 can be improved more efficiently.

### Second Embodiment

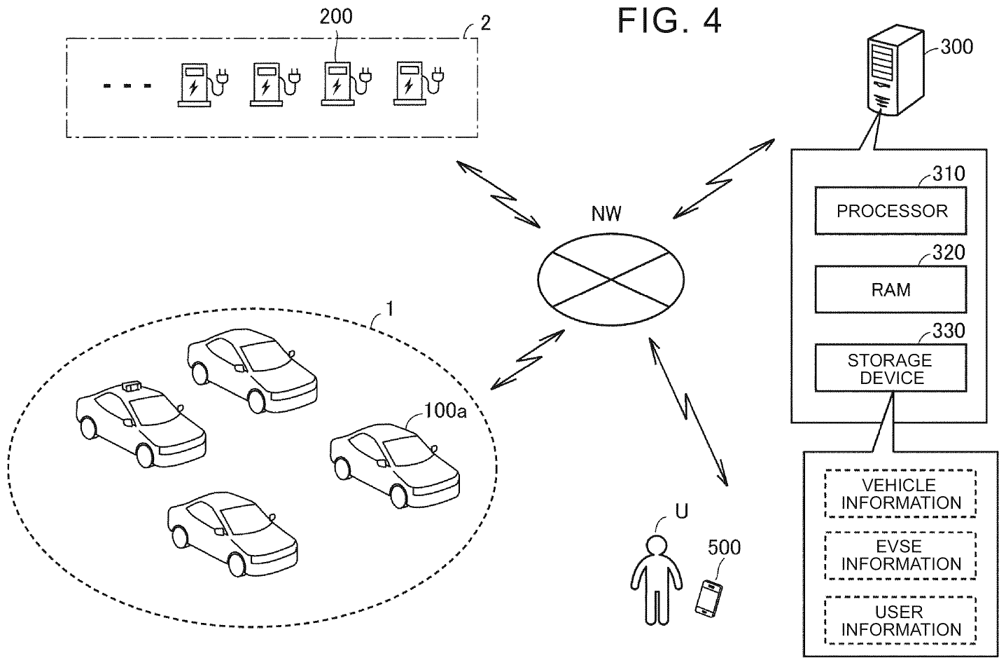

FIG. 4 is a diagram for describing a vehicle service according to the second embodiment. The vehicle service in the second embodiment is ride sharing (ride sharing service). Referring to FIG. 4, the rideshare vehicle group 1 includes a plurality of electrified vehicle 100a. Electrified vehicle 100a has a configuration in which the taxi vehicle 100 (see FIG. 1) omits the fare running meter 42 and the fare meter 81, and detailed explanation thereof is omitted. Electrified vehicle 100a (ECU 50) is configured to be able to communicate with the servers 300 through a networked NW.

The server 300 is a server that manages rideshare, and includes a processor 310, a RAM 320, and a storage device 330. The identification information (vehicle ID) of the respective electrified vehicle 100a included in the rideshare vehicle group 1 is registered in advance in the servers 300. The storage device 330 of the server 300 stores information related to electrified vehicle 100a (hereinafter, also simply referred to as “vehicle information”) separately in the vehicle ID. The vehicle-information includes a specification of electrified vehicle 100a (for example, a specification indicating the charge performance), a status of electrified vehicle 100a (for example, an empty status), and a position of electrified vehicle 100a. Electrified vehicle 100a sequentially transmits its location and status to the servers 300 via the networked NW. The servers 300 update the vehicular information based on the information (the most recent information) from electrified vehicle 100a.

EVSE-ID of the respective EVSE 200 included in EVSE group 2 are registered in advance in the servers 300. The storage device 330 of the servers 300 stores information related to EVSE 200 (hereinafter, also simply referred to as “EVSE information”) separately by EVSE-ID. EVSE includes the specifications of EVSE 200 (e.g., type of quick charger/normal charger, specifications indicating power output) and the location of EVSE 200 (installation location). EVSE may be obtained from the respective EVSE 200 via a networked NW.

The mobile terminal 500 is a user terminal used by the rideshare user U. The mobile terminal 500 is carried and operated by the user U. The mobile terminal 500 may be a smartphone including a touch panel display. The mobile terminal 500 communicates with the servers 300 through a networked NW. An application for ride sharing (hereinafter, also referred to as “dispatch application”) is installed in the mobile terminal 500. By the dispatch application, the identification information (terminal ID) of the mobile terminal 500 is registered in the server 300 in association with the communication address of the mobile terminal 500. The mobile terminal 500 can exchange information with the server 300 through the dispatch application. Further, the servers 300 distinguish and manage information on a plurality of users (hereinafter, also referred to as “user information”) by a terminal ID. The user information includes ride history information (for example, a service used in the past), point information (for example, a point acquired by the user through use of the service), and online payment information (account information, a payment date, a debit date, and the like).

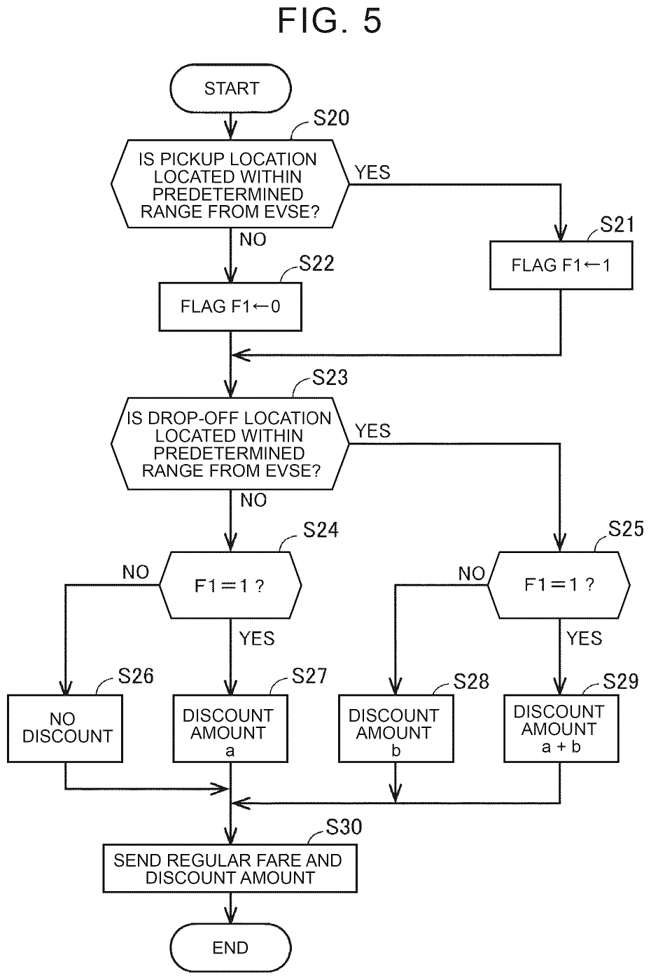

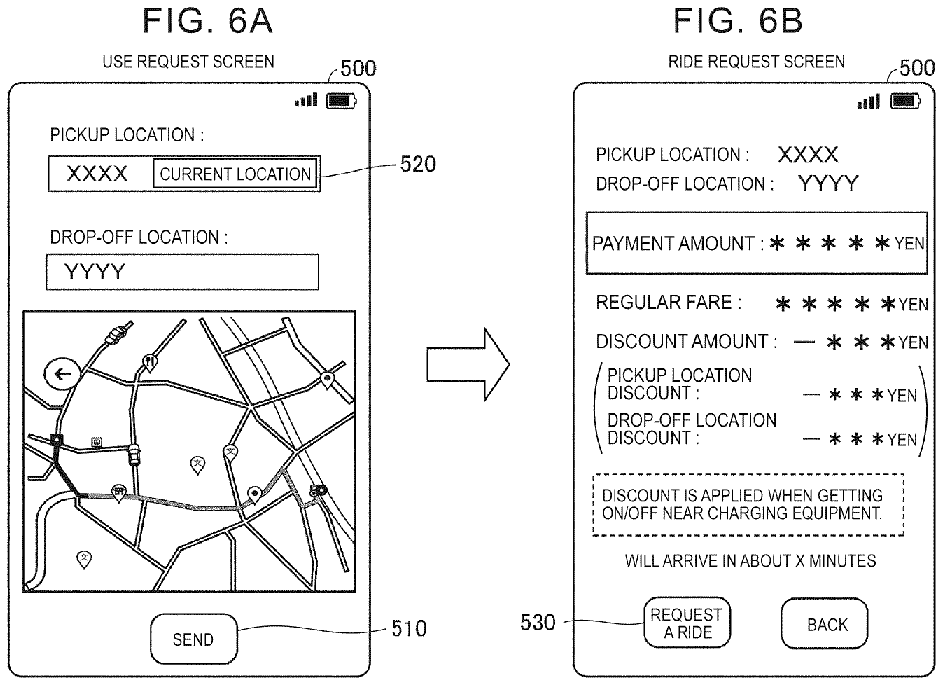

FIG. 5 is a flowchart for explaining a partial process of the dispatch service executed in the server 300. This flowchart is executed when a rideshare use request is transmitted from the mobile terminal 500. FIGS. 6A and 6B are diagrams showing a display screen (touch panel display) of the mobile terminal 500. For example, when the vehicle dispatch application of the mobile terminal 500 is launched, a screen of the rideshare use request (use request screen) shown in FIG. 6A is displayed. In the use request window of FIG. 6A, when the transmission button 510 is touched (tapped) after inputting the pickup location and the drop-off location, the rideshare use request is transmitted from the mobile terminal 500 to the server 300. In the input of the pickup location, the current location of the mobile terminal 500 may be input by tapping the current location button 52, and the address of the pickup location may be input. In addition, the pickup location may be input by tapping the pickup location in the map displayed on the use request screen. The input of the drop-off location may input the address of the drop-off location, and the drop-off location may be input by tapping the drop-off location on the map displayed on the use request screen.

Referring to FIG. 5, upon receiving the rideshare use request sent from the mobile terminal 500, the server 300 determines, in S20, whether at least one EVSE 200 is located within a predetermined range from the pickup location. The pickup location is a pickup location input to the mobile terminal 500. The location of EVSE 200 is obtained from EVSE stored in the storage device 330. For example, if there is at least one EVSE 200 within a predetermined distance (e.g., 500 m) from the pickup location, it is determined that the pickup location is within a predetermined range from EVSE 200, and the process proceeds to S21. The predetermined distance may be a linear distance or a path distance. When the EVSE 200 closest to the pickup location is not installed within the predetermined distance, a negative determination is made and the process proceeds to S22.

In S21, after the flag F1 is set to 1, the process proceeds to S23. In S22, after the flag F1 is set to 0, the process proceeds to S23. S23 determines whether at least one EVSE 200 is located within a predetermined range from the drop-off location. The drop-off location is the drop-off location input to the mobile terminal 500. For example, if there is at least one EVSE 200 within a predetermined distance (e.g., 300 m) from the drop-off location, it is determined that the drop-off location is within a predetermined range from EVSE 200, and the process proceeds to S25. The predetermined distance may be a linear distance or a path distance. When EVSE 200 closest to the drop-off location is not located within the predetermined distance, a negative determination is made and the process proceeds to S24.

S24 determines whether or not the flag F1 is 1. When the flag F1 is 0, the flow proceeds to S26, and when the flag F1 is 1, the flow proceeds to S27. In S26, the discount amount is set to “none” (the discount amount is set to 0 yen). In S27, the discount amount is set to a.

S25 determines whether or not the flag F1 is 1. When the flag F1 is 0, the flow proceeds to S28, and when the flag F1 is 1, the flow proceeds to S29. In S28, the discount amount is set to b. In S29, the discount amount is set to a+b. a+b is a value obtained by adding b to the discount amount a set by S27.

After S29 is processed from S26, the process proceeds to S30. In S30, the regular fee and the discount amount are transmitted to the mobile terminal 500. The regular fee is calculated based on the route distance between the pickup location and the drop-off location. The discount amount is a discount fee set in any of S29 from S26.

When S30 is processed, this routine is terminated. FIG. 6B is a ride request window displayed on the mobile terminal 500 that has received the regular fee and the discount amount. Fee information such as payment amount, regular fee, discount amount is displayed on the ride request screen. The payment fee is an amount obtained by subtracting the discount amount from the regular fee. When the user permits the condition displayed on the ride request screen and taps the “request a ride” button 530, the ride request is transmitted from the mobile terminal 500 to the server 300. Upon receiving the ride request, the servers 300 dispatch electrified vehicle 100a.

In the second embodiment, when the rideshare pickup location or drop-off location is located within a predetermined range from the location where the EVSE 200 is installed, a discount amount is set as an incentive. Therefore, since the user gets on and off at a location close to EVSE 200, the charge times can be efficiently secured, and the operating rate of electrified vehicle 100a can be improved. As in the first modification, the discount amount may be set to be higher (the discount amount may be set to be higher) as EVSE 200 power is higher.

### Second Modification

In the second embodiment, when the rideshare pickup location or drop-off location is within a predetermined range from the location where EVSE 200 is installed, a discount amount is set as an incentive. However, it is also envisaged that EVSE 200 present within the predetermined range are in use and cannot charge electrified vehicle 100a. In the second modification, when there is no free space in EVSE 200 present within the predetermined range, the discount amount is not set (discount amount is set to 0 yen).

For example, in S20 (FIG. 5), when all EVSEs 200 present within the predetermined range from the pickup location are in use and there is no free space, a negative determination is made and the process proceeds to S22. Further, in S23, when all EVSEs 200 present within the predetermined range from the drop-off location are in use and there is no free space, a negative determination is made and the process proceeds to S26. Thus, when there is no free space in EVSE 200 and charging is difficult, the incentives are not given, so that the charging times can be efficiently secured and the operating rate of electrified vehicle 100a can be improved.

### Third Modification

The incentive for users is not limited to discount on the fee. For example, points may be given to the user. The points may be, for example, points available for future fee payment, purchase of other services or goods, etc.

For example, in S26 (FIG. 5), a process is performed such as “no point grant”, “point P1 grant” in S27, “point P2 grant” in S28, and “point P1+P2 grant” in S29. Then, S30 performs a process of “send regular fee and given points to the mobile terminal 500”, thereby displaying the payment amount (regular fee) and the given points on the ride request screen of the mobile terminal 500. In this way, the rideshare is also awarded as an incentive when the rideshare pickup location or drop-off location is located within the predetermined range from the location where EVSE 200 is installed. Therefore, it is possible to efficiently secure the charge times and improve the operation rate of electrified vehicle 100a.

In the above embodiments, it is determined whether or not the distance is within a predetermined range by using a linear distance or a path distance between the vehicle and EVSE 200. However, it is also possible to determine whether or not the vehicle is within a predetermined range by using the arrival time (travel time) from the vehicle to EVSE 200.

The embodiment disclosed herein should be considered as illustrative and not restrictive in all respects. The scope of the present disclosure is shown by the claims rather than the above embodiment, and is intended to include all modifications within the meaning and the scope equivalent to those of the claims.

What is claimed is:

1. A method for providing a vehicle service for transporting a user in exchange for payment of a fee from a pickup location to a drop-off location, a vehicle in which the user rides being an electrified vehicle that is chargeable with a charging equipment, the method comprising:
determining whether either or both of the pickup location and the drop-off location are located within a predetermined range from a location of the charging equipment; and
providing an incentive when either or both of the pickup location and the drop-off location are located within the predetermined range.

2. The method according to claim 1, wherein the incentive is provided when the pickup location is a standby location where the charging equipment is installed.

3. The method according to claim 1, wherein when both the pickup location and the drop-off location are located within the predetermined range, a higher level of the incentive is provided than when either the pickup location or the drop-off location is located within the predetermined range.

4. The method according to claim 1, further comprising acquiring output power of the charging equipment located within the predetermined range, wherein the level of the incentive is set according to a magnitude of the output power.

5. The method according to claim 4, wherein the incentive is a discount on the fee.
